(19) United States
(12) Patent Application Publication
(10) Pub. No.: US 2012/0219076 A1
(43) Pub. Date: Aug. 30, 2012

(54) System and method of coded cooperation using amplify-and-forward scheme

(76) Inventors: Jun HEO, Seoul (KR); Jae Young Lee, Seoul (KR)

(21) Appl. No.: 13/035,178

(22) Filed: Feb. 25, 2011

(51) Int. Cl. H04L 27/00

(52) U.S. Cl. 375/259

(57) ABSTRACT

Provided are a system and method in which a user node forwards surplus information, which is forwarded from a counterparty user sharing a destination node, to the destination node by using cooperation communication in a network and, more particularly, a coded cooperation communication system and method using an amplify-and-forward (AF) scheme in which the user uses such a protocol that the user can forward the surplus information of the counterparty user to the destination node even in the case where the user fails to decoding the encoded surplus information of the counterparty user, so that it is possible to solve a problem of information unbalance.

### BACKGROUND

1. Technical Field

The present invention relates to a system and method in which a user node forwards surplus information, which is forwarded from a counterparty user sharing a destination node, to the destination node by using cooperation communication in a network and, more particularly, to a coded cooperation communication system and method using an amplify-and-forward (AF) scheme in which the user uses such a protocol that the user can forward the surplus information of the counterparty user to the destination node even in the case where the user fails to decoding the encoded surplus information of the counterparty user, so that it is possible to solve a problem of information unbalance.

2. Related Art

Protocols of a relay may be classified into two types of a decode-and-forward (DF) protocol and an amplify-and-forward (AF) protocol. FIG. 1 is a diagram illustrating the two types of protocols of the relay.

First, in the case of the DF protocol, the relay decodes received signals and, after that, re-encodes the signals. In the DF protocol, much more functions are allocated to the relay. However, the DF protocol has a disadvantage in that error propagation may occur if source and relay channel environments are not good.

On the contrary, in the case of the AF protocol, the relay merely amplifies received signals and, after that, forwards the signals. Therefore, the functions of the relay are simple, and the relay can have improved performance through the amplification. However, the AF protocol also has a disadvantage in that noise is also amplified. For these reason, each the relays is configured so as to use one of the two protocols according to the channel environment or the function of the relay.

On the other hand, as one type of existing user cooperation communication which is cooperation communication between user nodes (hereinafter, referred to as users), there is coded cooperation communication. The coded cooperation communication is cooperation communication used in IEEE80.15.3 based wireless personal area network (WPAN), where one user utilizes another user as a relay.

The coded cooperation communication is performed based on the aforementioned DF protocol, that is, one of the functions of the relay. In the coded cooperation communication, each user forwards information to a counterparty user and a destination node, and the counterparty user which receives the information denotes the received signal. The coded cooperation communication may be classified into four cases according to the type of information forwarded in the second frame according to success or failure in the decoding.

FIG. 2 is a view illustrating a table of the four cases of the coded cooperation communication. As described above, the coded cooperation communication may be mainly classified into the four cases according to the success or failure in the decoding of each of the associated users.

First, in all the four cases of the coded cooperation communication, each user forwards information to the counterparty user and the destination node in the first frame. Each user decodes the information received from the counterparty user. At this time, Case 1 of the coded cooperation communication is the case where each user succeeds in the decoding of the received signal. If each user succeeds in the decoding like Case 1, in the second frame, each user forwards surplus information of the information (hereinafter, referred to as counterparty information) received from the counterparty user. Since not the surplus information of the user but the surplus information of the counterparty information is forwarded in the second frame, it is possible to obtain a diversity gain. Case 2 of the coded cooperation communication is the case where all users cannot succeed in the decoding. If each user does not succeed in the decoding, the surplus information of the user itself other than the surplus information of the counterparty information is forwarded in the second frame. Cases 3 and 4 are the cases where one of the two users succeeds in the decoding. The user which succeeds in the decoding forwards the surplus information of the counterparty information, and the user which does not succeed in the decoding forwards the surplus information of the user itself. Therefore, in Case 3, since User 1 does not succeed in the decoding, both of the two users forward the surplus information of User 1 in the second frame. In Case 4, since User 2 does not succeed in the decoding, both of the two users forward the surplus information of User 2 in the second frame.

As described above, the coded cooperation communication has also a disadvantage. If the probability that only one user does not succeed in the decoding is increased, that is, if Case 4 frequently occurs from the viewpoint of User 1 (Case 4 from the viewpoint of User 2), only the surplus information of User 2 is forwarded in the second frame, so that the performance of User 1 is rapidly increased. Therefore, in order to solve information unbalance which may occur in this case, space-time cooperation communication has been proposed.

In the space-time cooperation communication, instead of forwarding only the surplus information of one user irrespective of the success or failure in the decoding in the second frame in the coded cooperation communication, the surplus information of the counterparty user and the surplus information of the user itself are forwarded in a mixed manner in the second frame.

FIG. 3 is a graph illustrating a performance of a Rician fading channel of the coded cooperation communication and the space-time cooperation communication. As understood from the graph, the performance of the protocols of the coded cooperation communication and the space-time cooperation communication is better than that of the protocol of no cooperation in terms of outrage probability. However, in comparison between the coded cooperation communication and the space-time cooperation communication, the performance of the space-time cooperation communication which is proposed in order to solve the information unbalance is not better than the performance of the coded cooperation communication.

As described hereinbefore, the user cooperation communication is mainly classified into the coded cooperation communication and the space-time cooperation communication. However, the performance of the space-time cooperation communication which is proposed in order to solve the problem of the information unbalance is not better than the performance of the coded cooperation communication. This denotes that, in the environment where one specific case frequently occurs, the performance of one user may be rapidly deteriorated.

### SUMMARY

The present invention is to propose a new protocol capable of solving a problem of information unbalance and having better performance than coded cooperation communication similarly to space-time cooperation communication.

According to an aspect of the present invention, there is provided a cooperation communication system using an amplify-and-forward (AF) scheme, which forwards encoded surplus information received from a counterparty user to a destination node to which information is to be forwarded by the counterparty user by using cooperation communication, including: a communication unit which receives a signal of the surplus information from the counterparty user; a coding/decoding unit which decodes the signal received through the communication unit; an amplification unit which amplifies the signal received through the communication unit; and a controller which controls the amplification unit to amplify the signal received through the communication unit and controls the communication unit to forward the signal to the destination node in the case where the signal received through the communication unit is not decoded by the coding/decoding unit.

In the above aspect, the controller may control the coding/decoding unit to encode the surplus information and control the communication unit to forward the encoded surplus information to the destination node in the case where the signal is decoded by the coding/decoding unit.

According to another aspect of the present invention, there is provided a coded cooperation communication method using an amplify-and-forward (AF) scheme, in which a user forwards surplus information of a counterparty user which shares a destination node, including: a first step in which the counterparty user forwards a signal of the encoded surplus information to the user; a second step in which the user receives the signal and decodes the signal; and a third step in which, in the case where the user fails in the decoding as a result of the second step, the user amplifies the signal and forwards the signal to the destination node.

In the above aspect, in the first step, the counterparty user may forward the information except for the surplus information among the information including the surplus information to the destination node.

In addition, in the third step, in the case where the user succeeds in the decoding as a result of the second step, the user may encode the decoded surplus information and forward the encoded surplus information.

According to the present invention, in the case where each user does not succeeds in the decoding in the coded cooperation communication, the user uses the protocol where the user does not forward the surplus information of the user itself but amplifies and forward the received signal using the AF scheme, so that it is possible to improve whole performance. In addition to the improvement of the performance, the information unbalance is solved by using the new protocol, so that it is possible to prevent rapid deterioration of the performance of one user even in the case where one specific case frequently occurs.

### BRIEF DESCRIPTION OF THE DRAWINGS

The invention will be described with reference to the accompanying drawings, wherein like numbers reference like elements.

FIG. 1 is a diagram illustrating two types of protocols of a relay.

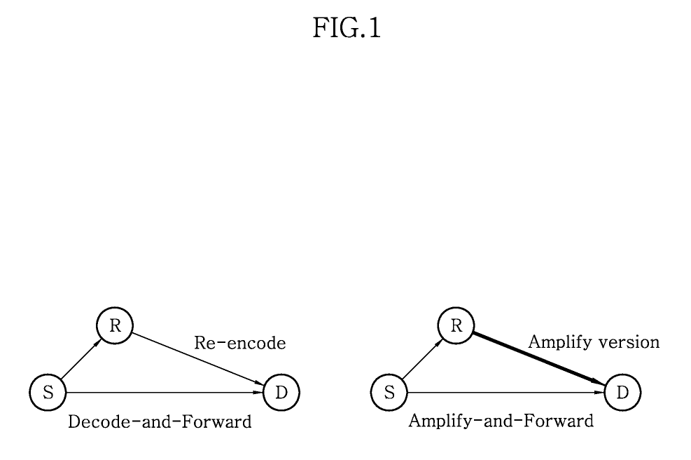

FIG. 2 is a view illustrating a table of four cases of an existing coded cooperation communication.

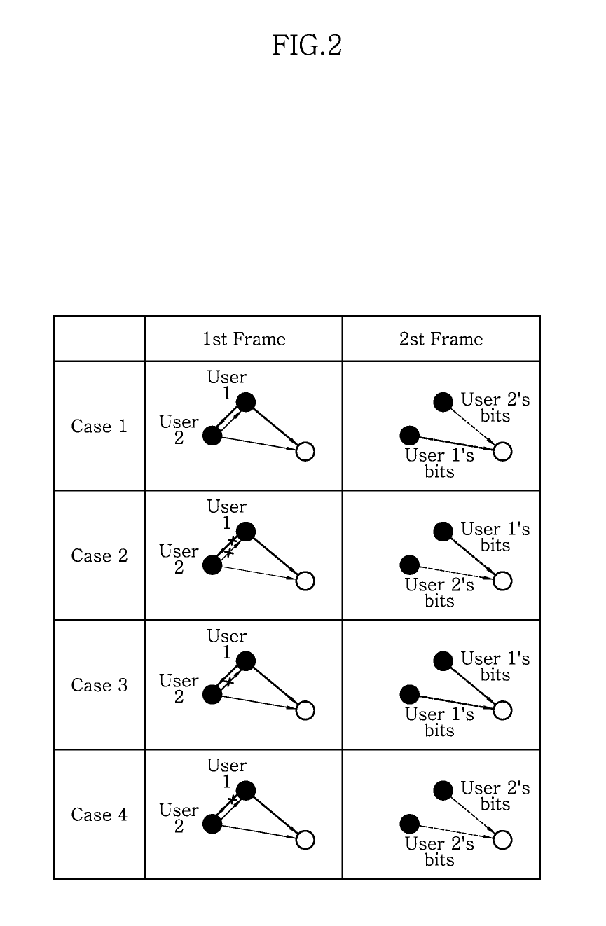

FIG. 3 is a graph illustrating an outrage probability with respect to an increase in rate in a Rician fading channel.

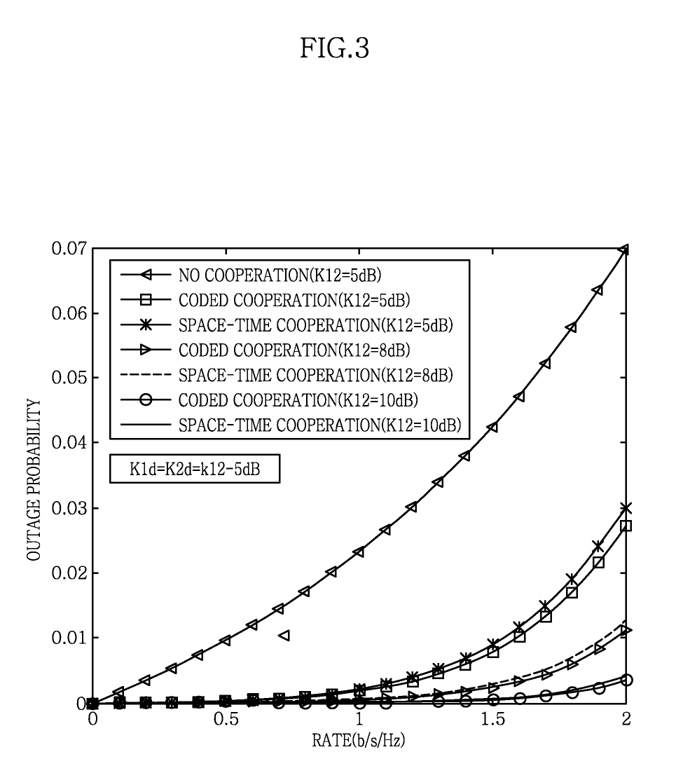

FIG. 4 is a diagram illustrating a configuration of a coded cooperation communication system according to the present invention.

FIG. 5 is a view illustrating a table of four cases of a coded cooperation communication protocol according to the present invention.

FIG. 6 is a graph illustrating an outrage probability with respect to an increase in SNR (signal-to-Noise Ration) in a Rayleigh fading channel of a system using a coded cooperation communication protocol according to the present invention.

FIG. 7 is a graph illustrating an outrage probability with respect to an increase in rate (b/s/Hz) of a coded cooperation communication system using an amplify-and-forward (AF) scheme according to the present invention.

FIG. 8 is a flowchart illustrating a coded cooperation communication method using an AF scheme according to the present invention.

### DESCRIPTION OF EXEMPLARY EMBODIMENTS

The present invention relates to a system and method using a new protocol in which, in the case where each user fails in decoding a signal received from a counterparty user in coded cooperation communication, the user does not forward surplus information of the user itself but amplifies and forwards the signal.

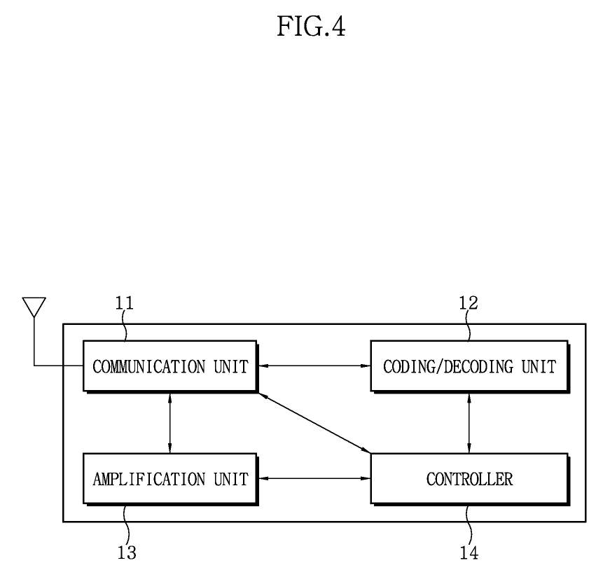

First, in order to use the protocol, each of users which share a destination node may have a configuration of a system illustrated in FIG. 4. Referring to FIG. 4, the coded cooperation communication system using the AF scheme may be configured to include a communication unit 11 which receive a signal of the surplus information from the counterparty user, a coding/decoding unit 12 which decodes the signal received through the communication unit 11, a amplification unit 13 which amplifies the signal received through the communication unit 11, and a controller 14 which controls the amplification unit 13 to amplify the signal and forwards the signal through the communication unit 11 to the destination node in the case where the signal received through the communication unit 11 is not decoded by the coding/decoding unit.

In other words, the controller 14 selectively controls the coding/decoding unit and the amplification unit according to success or failure in the decoding with respect to the surplus information of the counterparty information received the counterparty user. In the case where the signal of the surplus information is decoded by the coding/decoding unit 12, the controller 14 controls the coding/decoding unit 12 to encode the decoded surplus information of the counterparty user and controls the communication unit 11 to forward the encoded surplus information to the destination node. In the case where the signal of the surplus information is not decoded, the controller 14 controls the amplification unit 13 to amplify the signal and, after that, controls the communication unit 11 to forward the signal.

In other words, in the case where the user having the aforementioned configuration of the system fails in decoding the received signal, the received signal is amplified and forwarded to the destination node. Therefore, even in the case where the signal is not decoded, the destination node easily extracts the information of the counterparty user, which fails in decoding, from the amplified signal, so that it is possible to solve the problem of information unbalance.

In addition, due to the extraction of information from the amplified signal performed by the destination node, the reception rate of each user is increased, so that it is possible to prevent deterioration in performance of any one user and it is possible to increase information acquisition possibility of the destination node.

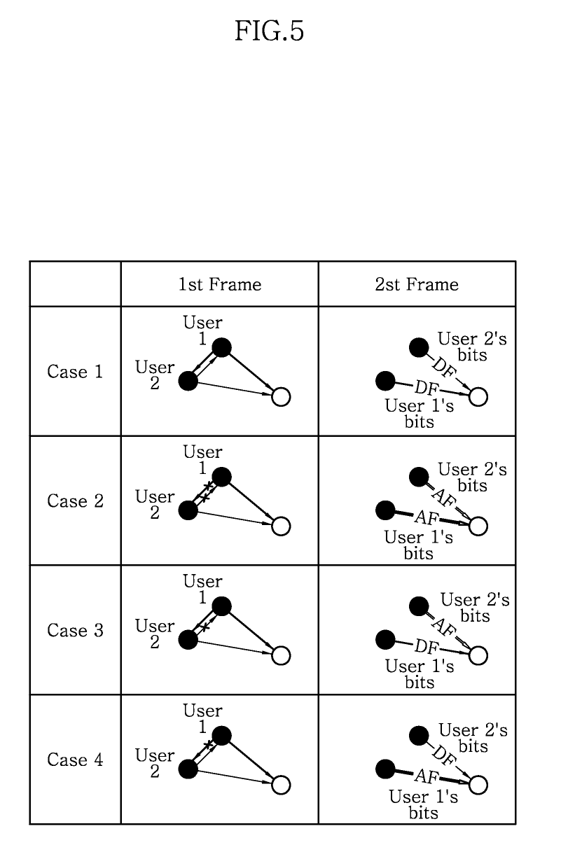

FIG. 5 illustrates whole cases of the coded cooperation communication using the protocol according to the present invention. The coded cooperation communication may be classified into four cases according to the success or failure in the decoding of each user. Among them, Case 1 is the same as the existing coded cooperation communication.

In the first frame, each user forwards information of the user itself to the counterparty user and the destination node. Each user succeeds in decoding the received information and forwards surplus information of the information (hereinafter, referred to as counterparty information) received by the user itself to the destination node in the second frame. In this method, each user forwards not the surplus information of the user itself but the surplus information of the counterparty information to the destination node, so that it is possible to obtain path diversity.

Case 2 is the case where each user receives counterparty information and both of the two users do not succeed in decoding. In this case, in the existing coded cooperation communication, each user needs to forward the surplus information of the user itself. However, according to the present invention, in Case 2, when both of the two users do not succeed in decoding, each user amplifies and forwards the signal of the surplus information received from the counterparty user instead of the surplus information of the user itself.

Therefore, according to the present invention, in Case 2, similarly to Case 1, it is possible to obtain the path diversity by amplifying the counterparty information by using the protocol. Accordingly, it is possible to improve performance.

The advantage of the protocol proposed by the present invention can be mainly obtained from Cases 3 and 4. In the existing coded cooperation communication, when User 1 does not succeed in the decoding, each of Users 1 and 2 forwards the surplus information of User 1. However, in the embodiment, in Case 3, when User 1 does not succeed in the decoding, User 1 amplifies the signal received from User 2 and forwards the signal to the destination node.

In other words, User 1 forwards the amplified signal of User 2 and User 2 forwards the surplus information of User 1, so that it is possible to eventually solve information unbalance which occurs in the existing coded cooperation communication where only the surplus information of User 2 is forwarded. Therefore, in the case where failure in the decoding in User 1 frequently occurs, in the existing coded cooperation communication, the performance of User 2 is rapidly deteriorated. On the contrary, in the new protocol according to the embodiment of the present invention, due to information balance between two users, it is possible to prevent rapid deterioration in the performance of User 2.

In Case 4, the functions of two users are opposite to those of Case 3. In other words, in the case where User 2 does not succeed in the decoding of the information of User 1, User 2 amplifies the signal received from User 1 and forwards the amplified signal. In addition, as described above, User 1 forwards the surplus information of User 2, so that it is possible to solve the problem of information unbalance and to prevent deterioration in performance of User 1.

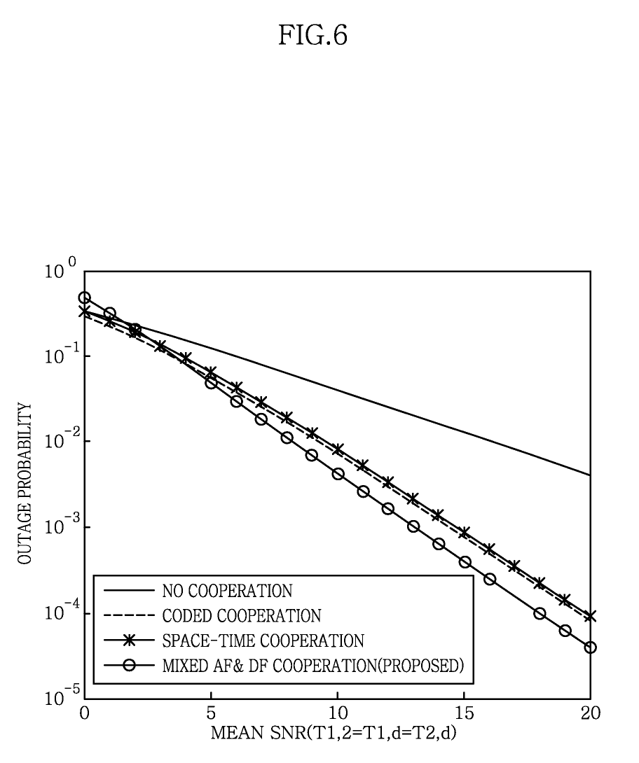

FIG. 6 is a graph illustrating an outrage probability with respect to an increase in SNR (signal-to-Noise Ration) in a Rayleigh fading channel. FIG. 6 illustrates comparison of the system using the protocol according to the present invention with the existing coded cooperation communication and space-time cooperation communication in terms of the outrage probability. It can be understood from the graph that the performance of the protocol according to the present invention is higher than the performance of the existing protocols. This may be considered to be the difference in the performance of solving the information unbalance. In addition, this denotes that the AF protocol has better performance at a low rate.

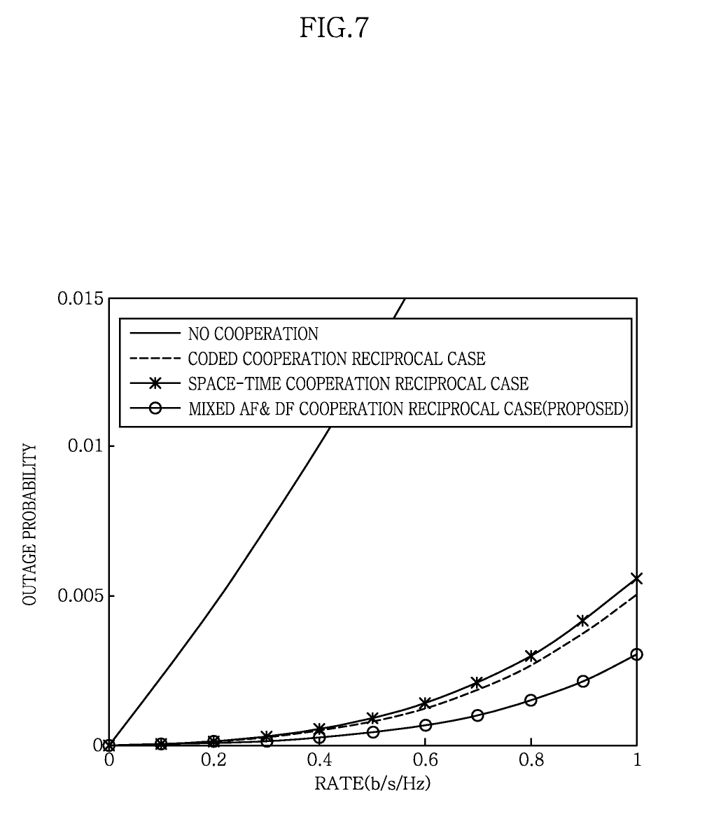

FIG. 7 is a graph illustrating an outrage probability with respect to an increase in rate (b/s/Hz) of a coded cooperation communication system using the AF scheme according to the present invention. Similarly to FIG. 6, FIG. 7 illustrates comparison of the system using the protocol according to the present invention with the existing coded cooperation communication and space-time cooperation communication. It can be understood from the graph that, even in the case where the rate is increased, in the protocol according to the present invention, the loss of the signal is smaller than that in the coded cooperation communication and the space-time cooperation communication, so that higher performance can be obtained.

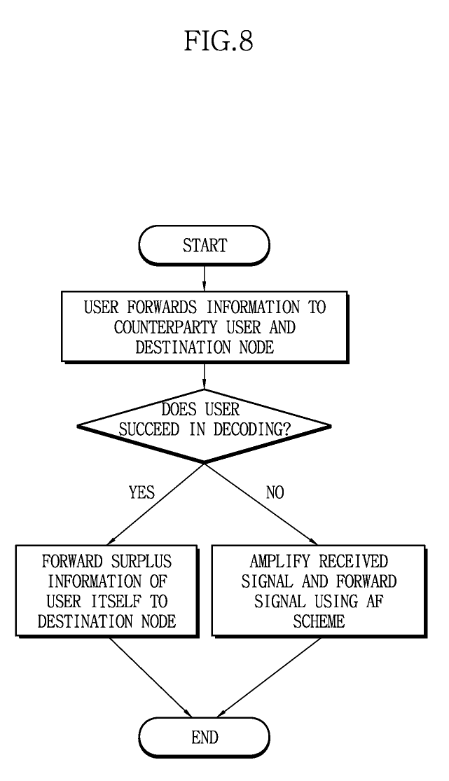

FIG. 8 is a flowchart illustrating the coded cooperation communication method using the AF scheme according to the present invention. First, the user forwards a portion of the information, which is to be forwarded, to the destination node. The user encodes the surplus information, that is, the remaining portion of the information except for the forwarded portion of the information and forwards the encoded surplus information to the counterparty user. Similarly, the counterparty user forwards a portion of the information, which is to be forwarded, to the destination node. The counterparty user encodes the surplus information, that is the remaining portion of the information except for the portion of the information forwarded to the destination node and forwards the encoded surplus information to the user.

Next, the user decodes the surplus information of the counterparty user. In the case where the user succeeds in decoding the surplus information of the counterparty user, the user forwards the decoded surplus information of the counterparty user to the destination node. At this time, the user may encode the surplus information and forward the surplus information. In addition, the counterparty user may also encode the surplus information of the user and forward the surplus information of the user.

On the contrary, in the case where the user does not succeed in decoding the surplus information of the counterparty user, the user amplifies the signal of the surplus information received from the counterparty user and forwards the amplified signal to the destination node. Therefore, it is possible to increase information acquisition possibility of the destination node and to prevent deterioration in performance of the counterparty user.

In addition, similarly to the user, the counterparty user also decodes and forwards the surplus information of the user or amplifies and forwards the surplus information of the user according to the success or failure in the decoding of the surplus information of the user. Therefore, it is possible to prevent loss in the information of the user or the counterparty user. Accordingly, it is possible to solve the problem of information unbalance in the destination node.

What is claimed is:

1. A cooperation communication system using an amplify-and-forward (AF) scheme, which forwards encoded surplus information received from a counterparty user to a destination node to which information is to be forwarded by the counterparty user by using cooperation communication, comprising:
a communication unit which receives a signal of the surplus information from the counterparty user;
a coding/decoding unit which decodes the signal received through the communication unit;
an amplification unit which amplifies the signal received through the communication unit; and
a controller which controls the amplification unit to amplify the signal received through the communication unit and controls the communication unit to forward the signal to the destination node in the case where the signal received through the communication unit is not decoded by the coding/decoding unit.

2. The cooperation communication system using the AF scheme according to claim 1, wherein the controller controls the coding/decoding unit to encode the surplus information and controls the communication unit to forward the encoded surplus information to the destination node in the case where the signal is decoded by the coding/decoding unit.

3. A coded cooperation communication method using an amplify-and-forward (AF) scheme, in which a user forwards surplus information of a counterparty user which shares a destination node, comprising:
a first step in which the counterparty user forwards a signal of the encoded surplus information to the user;
a second step in which the user receives the signal and decodes the signal; and
a third step in which, in the case where the user fails in the decoding as a result of the second step, the user amplifies the signal and forwards the signal to the destination node.

4. The coded cooperation communication method using the AF scheme according to claim 3, wherein in the first step, the counterparty user forwards the information except for the surplus information among the information including the surplus information to the destination node.

5. The coded cooperation communication method using the AF scheme according to claim 3, wherein in the third step, in the case where the user succeeds in the decoding as a result of the second step, the user encodes the decoded surplus information and forwards the encoded surplus information.
